(19) United States
(12) Patent Application Publication
(10) Pub. No.: US 2002/0118726 A1
(43) Pub. Date: Aug. 29, 2002

(54) System and electronic device for providing a spread spectrum signal

(75) Inventors: Xiaojing Huang, Waverton (AU); Yunxin Li, Ryde (AU)

Correspondence Address: MOTOROLA, INC., 1303 EAST ALGONQUIN ROAD, IL01/3RD, SCHAUMBURG, IL, 60196

(73) Assignee: MOTOROLA, INC

(21) Appl. No.: 09/795,758

(22) Filed: Feb. 28, 2001

(51) Int. Cl. H04K 1/00

(52) U.S. Cl. 375/141

(57) ABSTRACT

A system and electronic device (100) for providing a spread spectrum signal. The device (100) has a modulator (140), digital signal providing circuitry (130) coupled to the modulator (140), a modulation pseudo noise sequence generator (110) having a sequence output coupled to the modulator (140) and an output unit (150) coupled to the modulator (140). In use, the digital signal providing circuitry (130) provides data bits each of which is modulated, by the modulator (140), with a pseudo noise sequence supplied from modulation pseudo noise sequence generator (110) to thereby provide the spread spectrum signal that is transmitted by the output unit (150). There is also a demodulator (170) and input unit (160) for demodulating received spread spectrum signals.

### FIELD OF THE INVENTION

This invention relates to a Direct Sequence Spread Spectrum (DSSS) system and an electronic device for providing a DSSS signal. The invention is particularly useful for, but not necessarily limited to, systems and devices with radio frequency communication links.

### BACKGROUND OF THE INVENTION

Spread Spectrum (SS) technologies have been used for anti-jamming and security communications systems as well as commercial cellular and other wireless communications networks. Recently, an unconventional form of SS technology, namely ultra-wideband (UWB) technology, has attracted a great deal of attention because of its unique advantages over other conventional SS systems. One of the most important characteristics of the UWB signals is that their bandwidths could be orders of magnitude more than that of the conventional SS systems. Due to their ultra-wide bandwidth, UWB signals demonstrate unique properties such as high time-resolution and deep materials penetration. UWE technology may enable the realisation of exceptionally high performance, low cost wireless communications systems with improved capacity. These UWB systems include wireless cable replacement devices, ultra-high speed Local Area Networks (LANs), and ultra-low power wireless links for Personal Area Networks (PANs).

A major concern of UWB systems is that they could potentially interfere with existing communications systems because the emission bandwidth of UWB devices generally exceeds one gigahertz and may be greater than ten gigahertz. Furthermore, when generated by conventional direct sequence (DS) modulation or pulse position modulation, UWB signals contain a number of spectral peaks and/or spectral lines which could be harmful to, or at least interfere with, other communications systems.

### SUMMARY OF THE INVENTION

According to one aspect of the invention there is provided an electronic device for providing a spread spectrum signal, the device comprising: a modulator having a modulator output; digital signal providing circuitry having a signal output coupled to a signal input of the modulator; a modulation pseudo noise sequence generator having a sequence output coupled to a sequence input of said modulator; and an output unit coupled to the modulator output, wherein, in use, the digital signal providing circuitry provides data bits each of which is modulated, by the modulator, with a pseudo noise sequence supplied from the modulation pseudo noise sequence generator to thereby provide the spread spectrum signal that is transmitted by said output unit.

Suitably, the output unit may include a radio transmitter.

The output unit may include a modem. Preferably, the output unit may provide for connection and transmission of said spread spectrum signal to a wired communication link.

Suitably, said pseudo noise sequence generator may include a finite state machine. The modulation pseudo noise sequence generator may suitably includes a sequence combiner coupled to said finite state machine, wherein, in use, pseudo noise data bits associated with cyclical states of said finite state machine are sequentially combined into a sequence by said sequence generator to provide said pseudo noise sequence. Preferably, modulation of the data bits may be synchronized with the pseudo noise sequence.

The electronic device may be a radio communication device such as a two-way radio communication device and the digital signal providing circuitry may be coupled to a microphone. Typically, the signal providing circuitry preferably includes a digital data store.

Preferably, the electronic device may include: a demodulator having a demodulator output; a demodulation pseudo noise sequence generator having a output coupled to an input of the demodulator; and an input unit with an output coupled to the demodulator wherein, in use, a spread spectrum signal received by said input unit is demodulated, by the modulator, with a pseudo noise sequence supplied from the demodulation pseudo noise sequence generator to thereby provide a digital signal.

Suitably, state transitions of the receiving finite state machine may be synchronized with the spread spectrum signal.

According to another aspect of the invention there is provided a spread spectrum signal communication system comprising: a communication link; and a plurality of electronic devices in communication with each other by the communication link, the electronic devices comprising: a modulator having a modulator output; digital signal providing circuitry having a signal output coupled to a signal input of the modulator; a modulation pseudo noise sequence generator having a sequence output coupled to a sequence input of the modulator; and an output unit coupled to said modulator output, wherein, in use, the digital signal providing circuitry provides data bits each of which is modulated, by said modulator, with a pseudo noise sequence supplied from the modulation pseudo noise sequence generator to thereby provide a spread spectrum signal that is transmitted by said output unit.

The electronic device of the spread spectrum signal communication system may suitably include any or all of the above elements or functions.

### BRIEF DESCRIPTION OF THE DRAWINGS

In order that the invention may be readily understood and put into practical effect, reference will now be made to preferred embodiments as illustrated with reference to the accompanying drawings in which:

FIG. 1 is a schematic block diagram of an electronic device for generating a DSSS signal in accordance with the invention;

FIG. 2 is a first preferred embodiment of schematic block diagram of a pseudo noise sequence generator comprising part of the electronic device of FIG. 1;

FIG. 3 is a second preferred embodiment of schematic block diagram of a pseudo noise sequence generator comprising part of the electronic device of FIG. 1; and

FIG. 4 is a schematic block diagram of a spread spectrum signal communication system.

### DETAILED DESCRIPTION OF PREFERRED EMBODIMENTS OF THE INVENTION

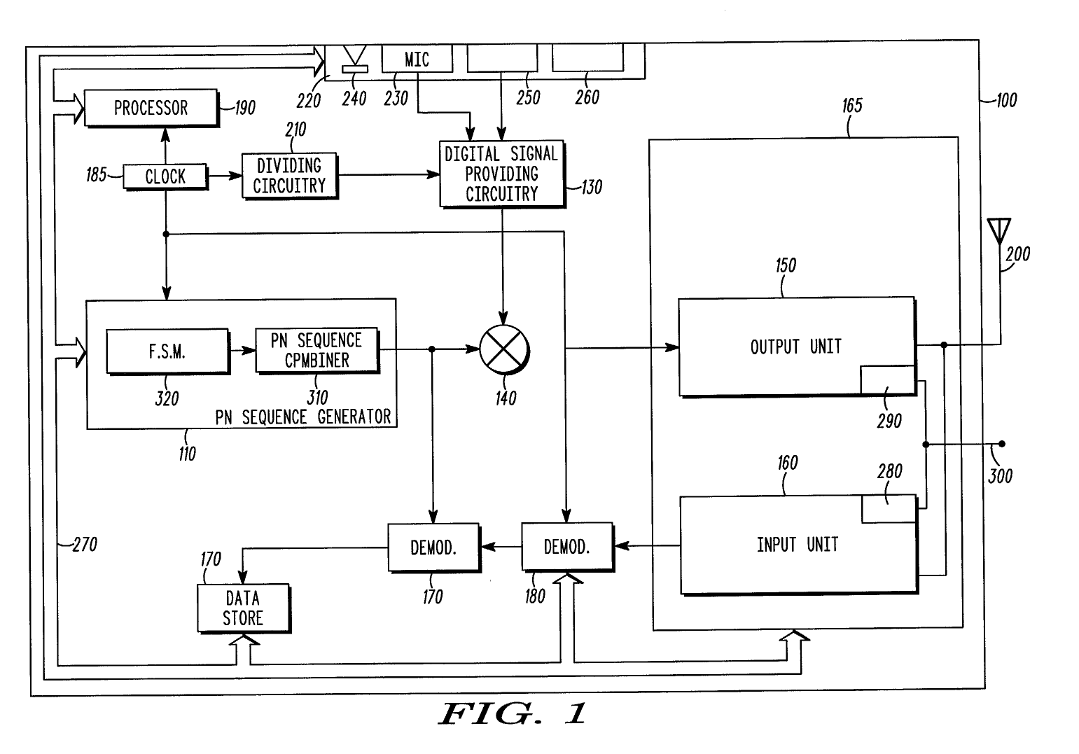

Referring to FIG. 1 there is illustrated a schematic block diagram of an electronic device 100 for providing a DSSS signal. The electronic device 100 is typically a single or two way radio communication device, it may also form part of a computer or other processing unit coupled to a network by a wired communication link or radio link. The electronic device 100 includes a combined common modulation pseudo noise sequence generator and a demodulation pseudo noise sequence generator hereafter referred to as pseudo noise sequence generator 110. The electronic device 100 also has a modulator 140 with a modulator output and a digital signal providing circuitry 130 coupled to a signal input of modulator 140. The pseudo noise sequence generator 110 has a sequence output coupled to an input of the modulator 140. There is also an output unit 150 coupled to the output of the modulator 140.

The electronic device 100 also includes a demodulator 170 with a demodulator output and an input unit 160 indirectly coupled to the demodulator 170 by a buffer 180. It will be apparent to a person skilled in the art that buffer 180 may form part of input unit 160. The pseudo noise sequence generator 110 has a sequence output coupled to an input of the demodulator 170 and an output of the demodulator 170 is coupled to digital data store 175. In order to provide synchronization of signals and pseudo noise sequences to modulator 140 and demodulator 170, the electronic device 100 includes a clock 185 with outputs coupled to a processor 190 (with associated memory not shown), pseudo sequence generator 110 and buffer 180. The clock is also indirectly coupled through dividing circuitry 210 to a digital signal providing circuitry 130. The output unit 150 includes a radio transmitter coupled to an antenna 200. The input unit 160 includes a radio receiver coupled to antenna 200.

There is also a user interface 220 having, in one embodiment, a microphone 230, a speaker 240, an input command or data device 250 (typically in the form of a keypad or interactive display screen) and an optional display screen 260. The microphone 230 and command device 250 are coupled to the digital providing circuitry 130 and a bus 270 couples processor 190 to the user interface, the pseudo noise sequence generator 110, data store 175, buffer 180 and a communication port 165 comprising the output unit 150 and input unit 160. The output unit 150 has a radio transmitter for transmitting spread spectrum signals by radio waves at common antenna 200. Input unit 160 has a radio receiver coupled to common antenna 200. There is also a transmitter modem 290 forming part of output unit 150 and a receiver modem 280 forming part of input unit 160. Alternatively, output unit 150 and input unit 160 may be compatible for direct network connection (by a wired communication link or otherwise), and provide an Ethernet port at a port node 300 of the communication port 165.

The pseudo noise sequence generator 110 includes a pseudo noise sequence combiner 310 coupled to a finite state machine 320. An output from the sequence combiner 310 is coupled to the sequence input of the modulator 140 and an input of the demodulator 170.

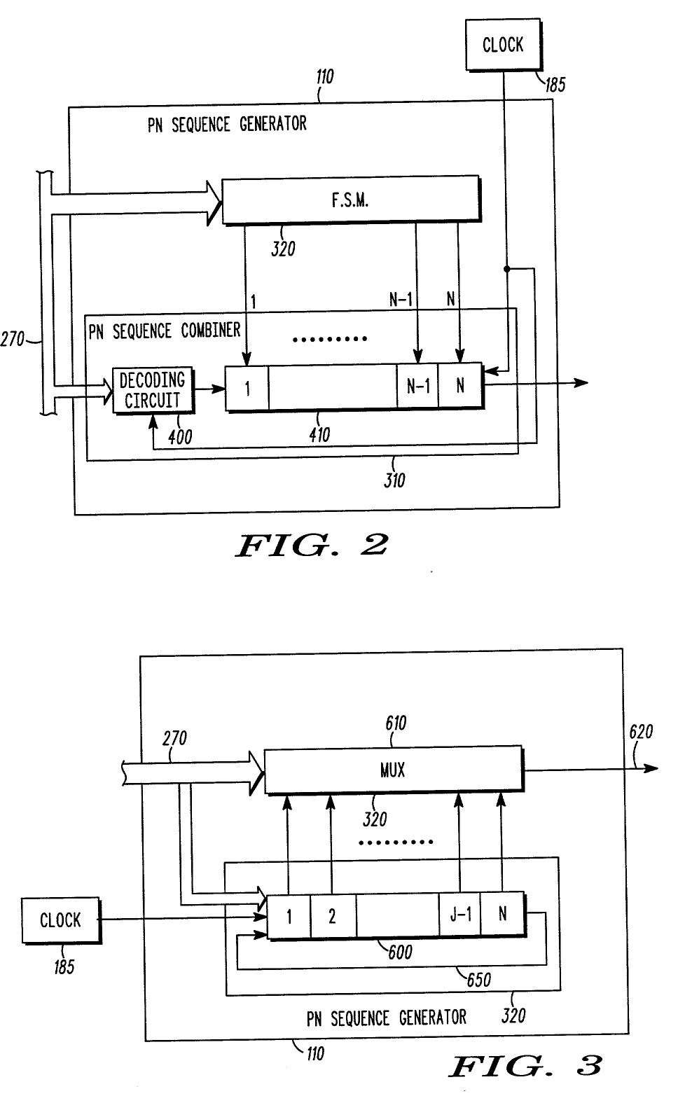

Referring to FIG. 2 there is illustrated a first preferred embodiment of schematic block diagram of the pseudo noise sequence generator 110 that includes the finite state machine 320 and pseudo noise sequence combiner 310. As will be apparent to a person skilled in the art, the finite state machine 320 can be implemented by a non-liner feedback shift register configuration or by pseudo random numbers stored in memory (typically a Read Only Memory). The pseudo noise sequence combiner 310 includes a decoding circuit 400 coupled to the bus 270, with a decoding circuit output providing a control signal to an N bit shift register 410. The finite state machine 320 has an N bit output bus each bit being coupled to a corresponding bit of the shift register 410. The clock 185 is also coupled to the shift register 410 and decoding circuit 400.

The Finite State Machine 320 has M states and each state is represented by a unique sequence of N random bits, where M and N can be any positive integer. For each time interval T, corresponding to a clock cycle at an output of the dividing circuitry 210, one data bit from the digital providing circuitry 130 is provided to modulator 140. Further, for each time interval T, the generated N random bit values by the Finite State Machine 320 are concurrently loaded into respective bits of the shift register 410, the loading being controlled by the decoding circuit 400 which counts the number of clock cycles from the clock 185. Once N random bit values are loaded into to shift register 410, they are shifted out to the modulator 140 during the time interval T. The pseudo noise sequence combiner 110 sequentially combines all N random bit values from all M states to provide output pseudo noise sequence whose period is M*T. Referring to both FIGS. 1 and 2, for each time interval T, the Modulator 140 receives one bit from the digital signal providing circuitry 130 and a sequence of N random bits from the pseudo noise sequence generator 110. Within each time interval T, the output waveform from the Modulator 140 varies with the value of the bit from the digital signal providing circuitry 130 and the bit sequence of N random bits from the pseudo noise sequence generator 110. The Modulator 140 modulates the pseudo noise sequence generated by the pseudo noise sequence generator 110 with the output of the digital signal providing circuitry 130 by digital signal modulation, resulting in a DSSS signal which is provided to the output unit 150.

The digital providing circuitry 130 is basically a buffer that receives data from the user interface 220. The electronic device 100 may also receive a spread spectrum signal at the input unit 160. This received spread spectrum signal is stored in the buffer 180 and demodulated by demodulator 170, wherein for each time interval T the demodulator 170 receives N bits from the buffer 180 and a sequence of N random bits from the pseudo noise sequence generator 110. The demodulated output from demodulator 170 is then stored in the data store 175 and if desired contents from this data store 175 can be sent to the user interface 220.

Referring to FIG. 3 there is illustrated a second preferred embodiment of schematic block diagram of the pseudo noise sequence generator 110. In this embodiment, the finite state machine 320 is a J (J>=N) bit shift register 600. Adjacent N arbitrarily assigned random bits of the shift register 600 provide a pseudo noise sequence for modulating one bit from the digital providing circuitry 130. Each adjacent N bits that provide a pseudo noise sequence can be conceptually regarded as one of M (M<=J) states of a Finite State Machine. An output from each bit of the shift register 600 is coupled to a multiplexer 610. The multiplexer 610 has a serial output 620 and is coupled to receive instructions from bus 270. The output from the Jth bit is also fed back, by a feedback loop 650, to the first bit of the shift register 600. The pseudo noise sequence generator 110 can provide an extended pseudo noise sequence of, for example, M*N bits. The pseudo noise generator 110 is initialised with a seed value that is effected after a command signal is provided by bus 270 to shift register 600. The pseudo noise generator 110 operates by firstly receiving a multiplexer control signal from bus 270 which enables serial output 620 and selects one of the J bits of shift register 600 to be coupled to output 620. A clock signal from clock 185 provides a shifting of data in the J bits and an enable signal to the multiplexer 610 so that the serial output 620 is only enabled during steady state conditions. In operation, after N clock cycles there will have been N bits provided at serial output 620. To provide an extended pseudo noise sequence, M of the J bits in the shift register 600 can be selected to be transparent to serial output 620 by providing multiplexer control signals to multiplexer 610. After M*N clock cycles, both multiplexer 610 and shift register 600 are reset and an extended pseudo noise sequence of period M*N can be provided at serial output 620.

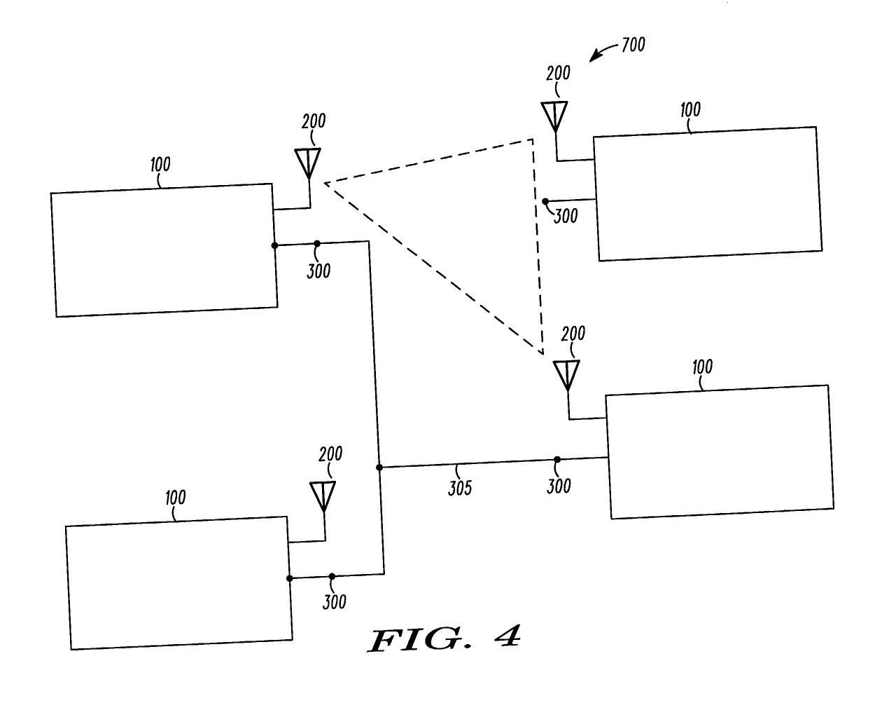

In FIG. 4. there is illustrated a schematic block diagram of a spread spectrum signal communication system 700 comprising a plurality of electronic devices 100 communicating with each other either by port nodes 300 coupled by wired communication links 305 or by antennas 200 using radio waves. As will be apparent to a person skilled in the art, received spread spectrum signals may be asynchronous and therefore synchronization techniques are used to demodulate the spread spectrum signal. One of the synchronization techniques is to correlate the received signal with the local pseudo noise sequence and find the maximum output of the correlation. Thus the received signal is synchronized at the epoch when the maximum correlation is reached.

The present invention operates such that the digital signal providing circuitry 130 typically receives data from the user interface. The digital signal providing circuitry 130 then provides data bits each of which is modulated, by modulator 140, with a pseudo noise sequence supplied from said modulation pseudo noise sequence generator 110 to thereby provide a spread spectrum signal that is transmitted by the output unit 150. Synchronization of modulation of data bits from the digital signal providing circuitry 130 with a pseudo noise sequence is provided by the clock 185 and dividing circuitry 210. Similarly, a spread spectrum signal received by the input unit 160 is temporarily stored in the buffer 180 and then demodulated, by the modulator 170, with the pseudo noise sequence supplied from the demodulation pseudo noise sequence generator 110 to thereby provide a digital signal.

At the system level, the electronic devices 100 communicate using the spread spectrum signal transmitted using the wired communication links 305 or by radio waves linked by the antennas 200. The invention may therefore alleviate at least one of the communication problems associated with spectral peaks or spectral lines.

Advantageously, by using extended pseudo noise sequence to modulate each bit of the digital signal provided from the digital signal providing circuitry, spectral properties are improved substantially. In this regard, by using an extended pseudo noise sequence, a normalized maximum power spectral density value can be shown to be 1+1/N if the original pseudo noise sequence is an m-sequence of period N. Further, the power spectral density has an envelope that is nearly flat and is basically nearly white in spectrum which can cause less interference to other communications.

Although the invention has been described with reference to preferred embodiments it is to be understood that the invention is not restricted to the particular embodiments described herein.

We claim:

1. An electronic device for providing a spread spectrum signal, said device comprising:
a modulator having a modulator output;
digital signal providing circuitry having a signal output coupled to a signal input of said modulator;
a modulation pseudo noise sequence generator having a sequence output coupled to a sequence input of said modulator; and
an output unit coupled to said modulator output, wherein, in use, said digital signal providing circuitry provides data bits each of which is modulated, by said modulator, with a pseudo noise sequence supplied from said modulation pseudo noise sequence generator to thereby provide the spread spectrum signal that is transmitted by said output unit.

2. An electronic device as claimed in claim 1, wherein said output unit includes a radio transmitter.

3. An electronic device as claimed in claim 1, wherein said output unit includes a modem.

4. An electronic device as claimed in claim 1, wherein said output unit provides for connection and transmission of said spread spectrum signal to a wired communication link.

5. An electronic device as claimed in claim 1, wherein said pseudo noise sequence generator includes a finite state machine.

6. An electronic device as claimed in claim 5, wherein said modulation pseudo noise sequence generator includes a sequence combiner coupled to said finite state machine, wherein, in use, pseudo noise data bits associated with cyclical states of said finite state machine are sequentially combined into a sequence by said sequence generator to provide said pseudo noise sequence.

7. An electronic device as claimed in claim 1, wherein modulation of said data bits with a pseudo noise sequence are synchronized.

8. An electronic device as claimed in claim 1, wherein said electronic device is a radio communication device.

9. An electronic device as claimed in claim 3, wherein said electronic device is a two-way radio communication device.

10. An electronic device as claimed in claim 1, wherein said digital signal providing circuitry is coupled to a microphone.

11. An electronic device as claimed in claim 1, wherein said signal providing circuitry includes a digital data store.

12. An electronic device as claimed in claim 1, wherein said electronic device includes:
a demodulator having a demodulator output;
a demodulation pseudo noise sequence generator having a output coupled to an input of said demodulator; and
an input unit with an output coupled to said demodulator wherein, in use, a spread spectrum signal received by said input unit is demodulated, by said demodulator, with a pseudo noise sequence supplied from said demodulation pseudo noise sequence generator to thereby provide a digital signal.

13. An electronic device as claimed in claim 1, wherein state transitions of said receiving finite state machine are synchronized with said spread spectrum signal.

14. A spread spectrum signal communication system, said system comprising:
a communication link; and
a plurality of electronic devices in communication with each other by said communication link, said electronic devices comprising:
a modulator having a modulator output;
digital signal providing circuitry having a signal output coupled to a signal input of said modulator;
a modulation pseudo noise sequence generator having a sequence output coupled to a sequence input of said modulator; and
an output unit coupled to said modulator output,wherein, in use, said digital signal providing circuitry provides data bits each of which is modulated, by said modulator, with a pseudo noise sequence supplied from said modulation pseudo noise sequence generator to thereby provide a spread spectrum signal that is transmitted by said output unit.

15. A spread spectrum signal communication system as claimed in claim 14, wherein said output unit includes a radio transmitter.

16. A spread spectrum signal communication system as claimed in claim 14, wherein said output unit includes a modem.

17. A spread spectrum signal communication system as claimed in claim 14, wherein said output unit provides for connection and transmission of said spread spectrum signal to a wired communication link.

18. A spread spectrum signal communication system as claimed in claim 14, wherein said modulation pseudo noise sequence generator includes a finite state machine.

19. A spread spectrum signal communication system as claimed in claim 18, wherein said modulation pseudo noise sequence generator includes a sequence combiner coupled to said finite state machine, and wherein, in use, pseudo noise data bits associated with cyclical states of said finite state machine are sequentially combined into a sequence by said sequence generator to provide said pseudo noise sequence.

20. A spread spectrum signal communication system as claimed in claim 14, wherein modulation of said data bits with a pseudo noise sequence are synchronized.

21. A spread spectrum signal communication system as claimed in claim 14, wherein said electronic device is a radio communication device.

22. A spread spectrum signal communication system as claimed in claim 14, wherein said electronic device is a two-way radio communication device.

23. A spread spectrum signal communication system as claimed in claim 14, wherein said digital signal providing circuitry is coupled to a microphone.

24. A spread spectrum signal communication system as claimed in claim 14, wherein said signal providing circuitry includes a digital data store.

25. A spread spectrum signal communication system as claimed in claim 14, wherein said electronic device includes:
a demodulator having a demodulator output;
a demodulation pseudo noise sequence generator having a output coupled to an input of said demodulator; and
an input unit with an output coupled to said demodulator wherein, in use, a spread spectrum signal received by said input unit is demodulated, by said demodulator, with a pseudo noise sequence supplied from said demodulation pseudo noise sequence generator to thereby provide a digital signal.

26. A spread spectrum signal communication system as claimed in claim 14, wherein state transitions of said receiving finite state machine are synchronized with said spread spectrum signal.
